(19) United States
(12) Patent Application Publication
(10) Pub. No.: US 2016/0335059 A1
(43) Pub. Date: Nov. 17, 2016

(54) PROCEDURE FOR REUTILIZATION OF MEANS IMPLEMENTED FOR BOARDING, PARTICULARLY FOR BOARDING AN AIRCRAFT

(71) Applicant: THALES, COURBEVOIE (FR)

(72) Inventors: Yvon Marc Jacques GATTI, Velizy Villacoublay (FR); Maurice Laurent Marcel BARDET, Pessac (FR); René Jean-Michel ANGÉ, Pessac (FR)

(21) Appl. No.: 15/151,398

(22) Filed: May 10, 2016

(30) Foreign Application Priority Data
May 11, 2015 (FR) 1500975

(51) Int. Cl. G06F 9/44; G06F 9/455

(52) U.S. Cl. CPC G06F 8/36; G06F 9/455

(57) ABSTRACT

A method for reusing certified capabilities for the implementation of a function on board an aircraft is disclosed. The certified capability can include a historical hardware platform associated with a historical software application. In one aspect, the method includes replacing the historical hardware platform with an updated hardware platform and associating the updated hardware platform with a software layer emulating the historical hardware platform, and instituting a functional interface between the historical software application and the updated hardware platform.

### CROSS-REFERENCE TO RELATED APPLICATIONS

This application claims the benefit under 35 U.S.C. §119 of French Application No. 15 00975, filed May 11, 2015, which is herein incorporated by reference in its entirety.

### BACKGROUND

1. Technological Field

The described technology generally relates to a method for reusing certified capabilities for the implementation of a function on board an aircraft.

2. Description of the Related Technology

It is known that since the 80s, onboard electronics play an increasingly significant role in avionics architectures, i.e., onboard electronic and computer capabilities.

Computers have gone from analog to digital, and the functions to be performed are then described by software run on processors.

Over the last three decades, the evolutions and innovations in the electronics field have been driven by the ever-growing needs of the markets, in particular military, regarding power, performance, integration, etc.

In the mid-90s, the continually increasing needs for so-called general public electronics changed the situation, these so-called general public needs becoming preponderant.

These changes resulted in a race toward the performance of increasingly powerful components, and thereby drove a growing decrease in the lifetime of electronic components in that application field (less than 10 years, for example).

Conversely, the aeronautics field wishes to be able to have a same component for several decades.

However, on the one hand, the race for performance, and on the other hand, the increase in the integration of functionalities of the components, for example, made possible by the etching fineness of the circuits, have driven profound changes in this hardware.

Thus, for example, we are seeing a drastic decrease in the power voltages of components from 5 volts a few years ago, to one volt today and less than one volt in the years to come.

This phenomenon still further accentuates the obsolescence of electronics components and reduces their lifetime.

Electronic equipment providers in these fields are therefore faced with a paradox, since on the one hand, they must deliver equipment to aircraft manufacturers for several tens of years, and on the other hand, the components that are used have decreasing lifetimes.

In order to manage this paradox, equipment manufacturers and suppliers of this type of hardware either make large inventories of components, covering the estimated needs for the years in question, or decide to redesign updated components that nevertheless remain compatible with the existing stock.

However, this results in the redesign of a whole, which must be done by keeping identical electrical, mechanical, environmental and functional interfaces of the existing equipment.

This redesign is embodied by new equipment within the hardware meaning of the term and by a new application (software) that must be redeveloped based on those that already exist and the capacities of the processor onboard the substitution equipment.

### SUMMARY OF CERTAIN INVENTIVE ASPECTS

One can therefore see that this presents a certain number of drawbacks, in particular regarding certified capabilities for the implementation of onboard functions, in particular onboard aircraft.

One objective of the described technology is therefore to resolve these problems.

To that end, one inventive aspect relates to a method for reusing certified capabilities for the implementation of a function onboard an aircraft, of the type including a historical hardware platform associated with a historical software application, comprising:
a. replacing the historical hardware platform with an updated hardware platform; and
b. associating the updated hardware platform with a software layer emulating the historical hardware platform, and a instituting capability forming a functional interface between the historical software application and the updated hardware platform.

According to one feature of this method, the emulating software layer is built from elementary emulation modules of elementary components or functions.

### BRIEF DESCRIPTION OF THE DRAWINGS

The described technology will be better understood from the following description, provided solely as an example and done in reference to the appended drawings, in which:

FIG. 1 illustrates the implementation of a reuse method according to the described technology, and

FIG. 2 illustrates the different obtained layers.

### DETAILED DESCRIPTION OF THE CERTAIN INVENTIVE EMBODIMENTS

The described technology therefore aims to propose a method that makes it possible to reuse certified capabilities, and in particular to facilitate the handling of the obsolescence of this type of capability, and in particular of certified capabilities for implementing onboard functions, in particular onboard aircraft.

This then makes it possible to limit the redesign of these capabilities to the hardware part, for example, struck by the obsolescence of the components including the processors, memories, programmable components and analog components, while keeping the application software intact.

This thus makes it possible to reduce the redevelopment, revalidation and recertification costs of the assembly quite significantly, since the application software remains that which already existed and is running in the same manner, down to the “bit”, but on an updated platform.

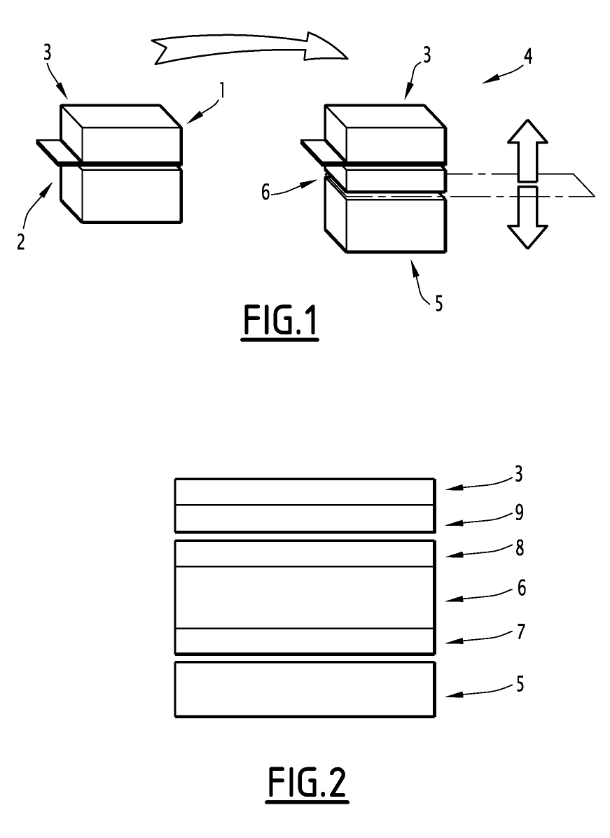

FIG. 1 in fact shows such certified capabilities that are designated by general reference 1, and which therefore traditionally include a hardware part designated by general reference 2 in this figure, on which an application is for example run, such as application software designated by general reference 3 in FIG. 1.

As previously indicated, the hardware may for example include a computer or other capability.

In the continuation of the description, this hardware 2 and this application software 3 will be called historical hardware platform and historical software application, respectively.

In order to resolve the different problems previously described, in particular regarding the obsolescence of the onboard hardware, in the method according to the described technology, it is proposed to replace the historical hardware platform with an updated hardware platform, and to associate the updated hardware platform with a software layer emulating the historical hardware platform, thus constituting a capability forming a functional interface between the historical software application and the updated hardware platform.

This is for example illustrated in this FIG. 1, where one can see that the reuse method according to the described technology results in the development of an updated capability designated by general reference 4 in this FIG. 1, in which the historical hardware platform 2 has been replaced by an updated hardware platform, designated by general reference 5.

The historical software application 3 does not change, and therefore remains associated with this new hardware.

However, according to the described technology, this updated hardware platform designated by reference 5 is associated with a software layer emulating the historical hardware platform.

This emulating software layer is designated by general reference 6 in this FIG. 1, and then constitutes a capability forming a functional interface between the historical software application 3 and the updated hardware platform 5.

This is illustrated in more detail in FIG. 2, where one can see the historical software application designated by general reference 3, the emulating software layer designated by general reference 6, and the updated hardware platform designated by general reference 5.

Indeed, in the method according to the described technology, an emulating software layer 6 should then be developed, for example, by building the emulating software layer 6 from elementary modules for emulating functions or components as implemented.

Interfaces are then also designed to interface this emulating layer 6, on the one hand with the updated hardware platform 5, this interface of this emulating layer being designated by general reference 7, and on the other hand, with the historical software application 3, this interface of this emulating layer being designated by general reference 8, and cooperating with an additional interface, designated by general reference 9, of the software application, designated by general reference 3.

One can see that this method makes it possible to reuse, without any modification in its source code or its executable, or in terms of its behavior, the set of existing software programs on an updated hardware platform, without having to retouch a single line of code thereof.

This is reflected by minimized revalidation and/or recertification costs.

Furthermore, this reuse method makes it possible to resolve problems such as not only handling of the obsolescence of the hardware platform housing the application software, for which one, for example, talks about existing computer maintenance, but also the processing related to the functional enrichment and/or increased performance on an existing computer.

This results in making it possible to have a historical software core coexist with new functions.

Lastly, it is also possible to merge functions and/or hardware such as computers or other capabilities, in order to reduce the energy and volume imprint of the solution.

Thus, advantages such as conservation of code, conservation of the certification credit, real-time operation, modularity and ease of configuration, etc., are provided.

As can be appreciated by one of ordinary skill in the art, each of the modules or software of the program(s) can include various sub-routines, procedures, definitional statements, and macros. Each of the modules are typically separately compiled and linked into a single executable program. Therefore, any description of modules or software is used for convenience to describe the functionality of the system. Thus, the processes that are undergone by each of the modules may be arbitrarily redistributed to one of the other modules, combined together in a single module, or made available in a shareable dynamic link library. Further each of the modules could be implemented in hardware.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein the instructions perform some or all of the steps of the above-described methods. The program storage devices may be, e.g., digital memories, magnetic storage media such as a magnetic disks and magnetic tapes, hard drives, or optically readable digital data storage media. The embodiments are also intended to cover computers programmed to perform the steps of the above-described methods.

While there have been shown and described and pointed out the fundamental novel features of the invention as applied to certain inventive embodiments, it will be understood that the foregoing is considered as illustrative only of the principles of the invention and not intended to be exhaustive or to limit the invention to the precise forms disclosed. Modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplate. All such modifications and variations are within the scope of the invention as determined by the appended claims when interpreted in accordance with the breadth to which they are entitled.

1-2. (canceled)

3. A method for reusing a certified capability for the implementation of a function onboard an aircraft, the certified capability including a historical hardware platform associated with a historical software application, the method comprising:
replacing the historical hardware platform with an updated hardware platform; and
associating the updated hardware platform with a software layer emulating the historical hardware platform, and instituting a functional interface between the historical software application and the updated hardware platform.

4. The method of claim 3, wherein the emulating software layer is built from elementary emulation modules of components or functions.

5. The method of claim 3, wherein the functional interface comprises:
a first interface between the historical software application and the emulating software layer; and
a second interface between the emulating software layer and the updated hardware platform.
